(19) United States
(12) Patent Application Publication
(10) Pub. No.: US 2023/0130528 A1
(43) Pub. Date: Apr. 27, 2023

(54) AI STUDIO SYSTEMS FOR ONLINE LECTURES AND A METHOD FOR CONTROLLING THEM

(71) Applicant: Wiseup Co., Ltd., Seoul (KR)

(72) Inventor: Ha Na KIM, Seoul (KR)

(73) Assignee: Wiseup Co., Ltd., Seoul (KR)

(21) Appl. No.: 17/514,779

(22) Filed: Oct. 29, 2021

(30) Foreign Application Priority Data
Oct. 27, 2021 (KR) 10-2021-0144941

(51) Int. Cl. G06F 3/14; G06K 9/00; H04N 5/232; H04N 5/222; G10L 15/22; G09B 5/06

(52) U.S. Cl. CPC G06F 3/1423; G06K 9/00335; G06K 9/00718; G09B 5/065; G10L 15/22; H04N 5/2228; H04N 5/23222; H04N 5/23229; G10L 2015/223

(57) ABSTRACT

The present invention relates to AI studio systems for online lectures and a method for controlling them, and more particularly, to AI studio systems for online lectures and a method for controlling them, which photograph a movement and a voice of a photographed subject which perform the online lectures analyze each of the movement and the voice from the photographed video to perform a command of the photographed subject through a control terminal unit based on analyzed contents.

### TECHNICAL FIELD

The present invention relates to AI studio systems for online lectures and a method for controlling them, and more particularly, to AI studio systems for online lectures and a method for controlling them, which photograph a movement and a voice of a photographed subject which perform the online lectures analyze each of the movement and the voice from the photographed video to perform a command of the photographed subject through a control terminal unit based on analyzed contents.

### BACKGROUND ART

The school education site in 2020 was facing a challenging reality such as initial online beginning of school, while undergoing critical circumstances such as the craze of Corona Virus infection.

In such circumstances, remote lectures and remote conferences using an online system could not but be performed for various academies, conferences, meetings, etc., in addition to a school.

Such a sudden change in environment becomes a spark which a lot of parts which switches are performed while facing in an existing offline system to an untact direction using the online system.

In such circumstances, since studios which are physically implemented are constrained in construction cost and a construction space, virtually constructed studios are frequently used for an untact education.

Related art related to the virtual studios was disclosed in Korean Patent Registration No. 10-1983727. The virtual studio in the related art was a system which is constituted by a video photographing unit camera attached with one or more studio markers installed in the studio and one or more arranged virtual camera markers and one or more marker photographing cameras installed to photograph the virtual camera marker, and photographs and recognizes a marker with a camera to form a virtual space.

However, since the related art focuses on constituting the virtual studio, an engineer for a separate control is required for a control of a screen in the virtual studio.

Accordingly, compared with a reality in which performing photographing solely is general and untact conferences or lectures are performed with minimal personnel, the related art requiring a separate engineer needs to be supplemented.

### PRIOR ART DOCUMENT

Korean Patent Registration No. 10-1983727 (Jun. 4, 2019)

### DISCLOSURE

### Technical Problem

The present invention is contrived to solve the problem, and the present invention relates to AI studio systems for online lectures and a method for controlling them, and more particularly, to AI studio systems for online lectures and a method for controlling them, which photograph a movement and a voice of a photographed subject which perform the online lectures analyze each of the movement and the voice from the photographed video to perform a command of the photographed subject through a control terminal unit based on analyzed contents.

### Technical Solution

In order to achieve the object, AI studio systems for online lectures according to the present invention may be configured to include:
a photographing apparatus unit 110 photographing a photographed subject;
a processing apparatus unit 120 receiving a video and a voice photographed by the photographing apparatus unit 110 and processing the video and voice;
a first monitor unit 130 receiving at least one image of a viewer from the processing apparatus unit 120 and displaying the image so as to be confirmed by the photographed subject;
a second monitor unit 140 receiving a currently output screen from the processing apparatus unit 120 and displaying the screen so as to be confirmed by the photographed subject; and
a control terminal unit 150 controlling the first monitor unit 130 and the second monitor unit 140 based on information of the processing apparatus unit 120.

The processing apparatus unit 120 may be configured to recognize a movement of the photographed subject in a video photographed by the photographing apparatus unit 110.

In this case, the processing apparatus unit 120 may be configured to control the first monitor unit 130 and the second monitor unit 140 through the control terminal unit 150 according to the recognized movement of the photographed subject.

Moreover, the processing apparatus unit 120 may be configured to recognize voice information photographed by the photographing apparatus unit 110.

In this case, the processing apparatus unit 120 may be configured to control the first monitor unit 130 and the second monitor unit 140 through the control terminal unit 150 according to a recognized voice command of the photographed subject.

Further, a method for controlling AI studio systems for online lectures according to the present invention may be configured to include:
an image photographing step (S01) of photographing an image including a movement and a voice of a photographed subject,
a video analysis step (S02) of analyzing the movement and the voice of the photographed subject included in the image photographed in the image photographing step (S01),
a control command delivery step (S03) of delivering a control command to a control terminal unit based on information analyzed in the image analyzing step (S02), and
a control performing step (S04) of performing a control of a first monitor unit and a second monitor unit through a control terminal unit based on the control command delivered in the control command delivery step (S03).

The image analysis step (S02) may be configured to include a movement recognition step (S02a) of recognizing the movement and a movement command judgment step (S02b) of judging the command of the photographed subject based on the recognized movement.

Further, the video analysis step (S02) may be configured to include a voice recognition step (S02c) of recognizing the voice, a voice analysis step (S02d) of analyzing voice contents through a natural language analysis based on the recognized voice, and a voice command judgment step (S02e) of judging the command of the photographed subject based on the analyzed contents.

### Advantageous Effect

In the AI studio systems for online lectures and a method for controlling them according to the present invention, since a photographed subject can perform an operation such as a desired screen operation by analyzing a movement or a voice of the photographed subject, the movement or voice of the photographed subject is analyzed and a manipulation suitable therefor is performed, and as a result, a more smooth lecture is possible as compared with a conventional virtual studio in which a flow of a lecture may be cut because a person for separate manipulation is provided in addition to the photographed subject or the photographed subject should personally perform a manipulation.

Moreover, as AI is used for recognition through the movement or voice of the photographed subject and the number of use times increases, an analysis speed and recognition efficiency increase, and as a result, a satisfaction level of the photographed subject can be enhanced as the AI studio systems are further used.

Moreover, since video mixing and chroma-key tasks performed through separate hardware in the related art are performed by software, cost required for making the virtual studio in the related art can be minimized.

### DESCRIPTION OF DRAWINGS

FIG. 1 illustrates an embodiment of AI studio systems for online lectures according to the present invention.

FIG. 2 illustrates an embodiment of a method for controlling AI studio systems for online lectures according to the present invention.

FIG. 3 illustrates an embodiment of a video analysis step according to the present invention.

### MODE FOR THE INVENTION

Hereinafter, the present invention will be described in more detail with reference to the accompanying drawings. Prior thereto, terms and words used in the present specification and claims should not be interpreted as being limited to typical or dictionary meanings, but should be interpreted as having meanings and concepts which comply with the technical spirit of the present invention, based on the principle that an inventor can appropriately define the concept of the term to describe his/her own invention in the best manner. In addition, unless otherwise defined, used technical terms and scientific terms have the same meaning as commonly understood by those skilled in the art to which the present invention belongs and in the following description and the accompanying drawings, a description of known functions and configurations that may unnecessarily blur the gist of the present invention is omitted.

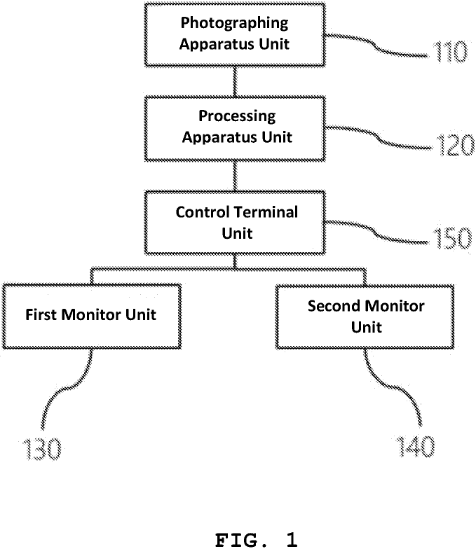

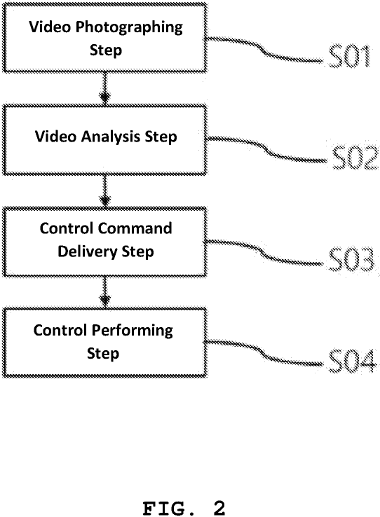

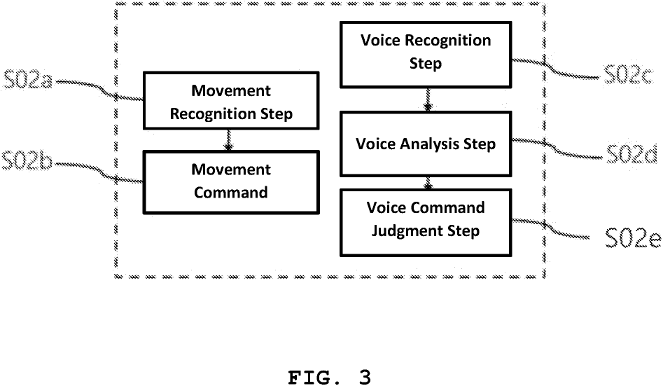

FIG. 1 illustrates an embodiment of AI studio systems for online lectures according to the present invention, FIG. 2 illustrates an embodiment of a method for controlling AI studio systems for online lectures according to the present invention, and FIG. 3 illustrates an embodiment of a video analysis step according to the present invention.

As illustrated in FIG. 1, the AI studio systems for online lectures according to the present invention may be configured to include
a photographing apparatus unit 110 photographing subject,
a processing apparatus unit 120 receiving a video and a voice photographed by the photographing apparatus unit 110 and processing the video and voice,
a first monitor unit 130 receiving at least one image of a viewer from the processing apparatus unit 120 and displaying the image so as to be confirmed by the photographed subject,
a second monitor unit 140 receiving a currently output screen from the processing apparatus unit 120 and displaying the screen so as to be confirmed by the photographed subject, and
a control terminal unit 150 controlling the first monitor unit 130 and the second monitor unit 140 based on information of the processing apparatus unit 120.

When more easily described, the photographing apparatus unit 110 photographing the photographed subject is constituted by a photographing apparatus photographing at least one moving picture to photograph the video and the voice of the photographed subject.

The processing apparatus unit 120 may be configured to recognize the movement and the voice of the photographed subject in the video photographed by the photographing apparatus unit 110.

An embodiment thereof is as follows.

An attempt to various methods a natural user interface (NUI) to be used for virtual reality applications is actively conducted. Among them, a user interface which is widely used is a gesture. The gesture includes an intended operation which the photographed subject performs in order to deliver an intention thereof and an operation which the photographed subject performs meaninglessly.

3D hand coordinate information of the photographed subject is detected through a leap motion sensor, an X-Y plane is made to an R channel, a Y-Z plane is made to a G channel, and a Z-X plane is made to a B channel, and the channels are combined to be created as a 2D RGB image. The created image is trained through a single shot multi-box detector (SSD) model which is one of convolution neural network (CNN) models to classify a hand gesture.

In this case, the photographing apparatus unit 110 may be configured to further include at least one sensor sensing the movement like the leap motion sensor, and may create and use a data set as if using the sensor through preprocessing of the processing apparatus unit 120 for the photographed image without a separate sensor.

In order to recognize the gesture of the photographed subject in real time, the gesture may be recognized by using a sliding window technique.

A hand gesture technique refers to a technique that recognizes, when a person performs a predetermined motion by using a hand, which motion the corresponding motion is. A pre-defined motion gesture is trained by the SSD model among the models of the artificial neural network CNN to continuously enhance such a recognition technique.

3D input data input through the leap motion sensor is converted into 2D data.

In this case, in general, a gesture pattern shows various shapes according to a scheme or a style taken by a user, whether a left hand or a right hand is used, etc. This deepens the complexity in recognizing the gesture. However, despite movement, distortion, size, tilting, time, etc., of input data the CNN model derives a result value via a feature extraction step and a classification step to effectively recognize the gesture and convert the gesture into 2D data.

Thereafter, the gesture is processed through the SSD model, and the SSD uses VGG-16 as a basis and detects an object of the image by using one deep neural network. In the case of the SSD, information is distributed in various hidden layers. A boundary box and class information are contained in 6 feature maps created through convolution of conv4_3, conv7, conv8_2, conv9_2, conv10_2, and conv11_2 as inputs. Sizes of all of the feature maps are different from each other, and height and width sizes gradually decrease to 38 ^{∗} 38, 19 ^{∗} 19, 10 ^{∗} 10, 5 ^{∗} 5, 3 ^{∗} 3, and 1*1. With respect to the total number of prediction boundary boxes, 8732 boundary boxes per class are predicted, and a non-maximum suppression (NMS) algorithm is used, which leaves a prediction box having a highest confidence and all of the remaining prediction boxes are removed among the prediction boxes. Through such a structure, a result having high accuracy may be derived without location estimation and a resampling process of an input video.

Moreover, in the case of the present invention, when the gesture is taken through the sliding window technique, the image is created in Unity3D, and each frame is created as one image, which is input into the SSD model. The AI studio systems for online lectures according to the present invention may enhance a recognition rate of the gesture through such an input of multiple frames.

Further, continuous machine learning is performed based on the acquired data to recognize the gesture at a higher speed than a similar movement, and as a result, as the photographed subject uses the AI studio systems for online lectures according to the present invention more, recognition efficiency of the system is enhanced, thereby enhancing use convenience.

The processing apparatus unit 120 may be configured to control the first monitor unit 130 and the second monitor unit 140 through the control terminal unit 150 according to the recognized movement of the photographed subject.

Accordingly, the movement recognized by the processing apparatus unit 120 involves a command meaning predetermined by each photographed subject and through this, a motion such as zoom-in of the screen, presentation mode setting, screen switching, etc., may be performed through the movement. Through this, in photographing of lectures, etc., various screen switching motions or various photographing related manipulations performed by personnel other than the conventional photographed subject may be performed only by the gesture of the photographed subject to minimize the number of persons required for photographing, thereby enhancing photographing convenience.

Moreover, the processing apparatus unit 120 may be configured to recognize voice information photographed by the photographing apparatus unit 110 through deep learning.

An embodiment of voice recognition of the processing apparatus unit 120 will be described below.

The voice recognition refers to receiving a voice of a person and outputting a sequence of a symbol corresponding to the voice. A problem definition of the voice recognition is to output a word sequence of a symbol showing a highest probability in the model when the sequence of the voice signal is given as an input.

In the voice recognition, an acoustic model refers to obtain a probability of generating an input speaking when the model is given. A model most widely used for the acoustic modeling is a hidden Markov model (HMM). This as a sequence modeling method based on a Markov chain is widely used as a solution of a problem which handles the sequence in addition to the voice recognition.

A problem which may be solved through the HMM is recognition, forced alignment, and learning. When the model is given, the recognition is a process of calculating a probability for an input an observation sequence and selecting a model in which the probability is the highest. During this process, a forward algorithm is used for calculating an HMM creation probability.

The forced alignment as a preprocessing process for model learning, determines a location at which a specific word is spoken in all learning materials and automatically extracts a material required for learning for each model. Through this, learning materials for each recognition unit may be created for data given for each word sequence. A viterbi algorithm is used for performing the forced alignment.

The learning is a process of updating a model parameter so that the probability of the corresponding material becomes the highest when the material is given.

An HMM parameter is updated until the probability becomes the highest so as to perform a recognition process for the given learning material. A viterbi training algorithm is used in the learning process.

A recognition problem of the HMM shows a high performance for the given learning material, but since a fixed feature parameter dimension of the learning material, there is a problem in that the recognition rate decrease noise or a voice having a different speaking characteristic.

In order to overcome the problem, the AI studio systems for online lectures according to the present invention uses a method for using a deep neural network (DNN) learnable while efficiently changing the feature parameter dimension. The DNN may have a higher voice recognition rate by replacing the recognition and the learning among three problems which may be solved by the HMM.

The processing apparatus unit 120 may be configured to control the first monitor unit 130 and the second monitor unit 140 through the control terminal unit 150 according to the recognized voice command of the photographed subject.

That is, the processing apparatus unit 120 may separate the voice off the photographed subject from sound data acquired through the photographing apparatus unit 110 and analyze the separated voice and recognize a command compared with a prestored voice command data set, and deliver the recognized command to the control terminal unit 150 and control the first monitor unit 130, the second monitor unit 140, other apparatuses, etc. In this case, the other apparatuses mean a recording volume, a volume of a video material, reproduction of the video material, etc.

Further, continuous machine learning is performed based on the voice or acquired voice recognition data like the deep learning of the movement to recognize the gesture at a higher speed than a similar pattern, and as a result, as the photographed subject uses the AI studio systems for online lectures according to the present invention more, recognition efficiency of the system is enhanced, thereby enhancing use convenience.

Further, the present invention may additionally include a video storage unit, a movement storage unit, a voice storage unit, a movement rejudgment unit, a voice rejudgment unit, a movement/command matching unit, a voice/command matching unit, a first recommendation unit, and a second recommendation unit.

The video storage unit may store a video photographed by the photographing apparatus unit 110, and the movement storage unit and the voice storage unit may store the movement and the voice recognized by the processing apparatus unit 120, respectively.

When the movement recognized by the processing apparatus unit 120 is not clear or the movement rejudgment unit intends to judge the recognized movement again, the movement rejudgment unit may recognize the movement from the video photographed by the photographing apparatus unit 110 again.

When the voice recognized by the processing apparatus unit 120 is not clear or the voice rejudgment unit intends to judge the recognized voice again, the voice rejudgment unit may recognize the voice from the voice photographed by the photographing apparatus unit 110 again.

The movement/command matching unit may match and store the movement recognized from the video photographed by the photographing apparatus unit 110 and a control command determined by analyzing the movement.

The processing apparatus unit 120 may recognize the movement from the video photographed by the photographing apparatus unit 110, confirm the control command from the recognized movement, and control the first monitor unit and the second monitor unit 140 in the control terminal unit 150 based on the confirmed control command.

When the first recommendation unit recognizes the movement from the video photographed by the photographing apparatus unit 110, the first recommendation unit may recommend the control command from the movement recognized based on the information stored in the movement/command matching unit. According to the present invention, the control terminal unit 150 may control the first monitor unit 130 and the second monitor unit 140 based on the recommended control command.

The voice/command matching unit may match and store the voice recognized from the video photographed by the photographing apparatus unit 110 and a control command determined by analyzing the voice.

The processing apparatus unit 120 may recognize the voice from the video photographed by the photographing apparatus unit 110, confirm the control command from the recognized voice, and control the first monitor unit and the second monitor unit 140 in the control terminal unit 150 based on the confirmed control command.

When the second recommendation unit recognizes the voice from the video photographed by the photographing apparatus unit 110, the first recommendation unit may recommend the control command from the voice recognized based on the information stored in the voice/command matching unit. According to the present invention, the control terminal unit 150 may control the first monitor unit 130 and the second monitor unit 140 based on the recommended control command.

As illustrated in FIG. 2, a method for controlling AI studio systems for online lectures according to the present invention may be configured to include
a video photographing step (S01) of photographing a video including a movement and a voice of a photographed subject,
a video analysis step (S02) of analyzing the movement and the voice of the photographed subject included in the video photographed in the video photographing step (S01),
a control command delivery step (S03) of delivering a control command to a control terminal unit based on information analyzed in the video analysis step (S02), and
a control performing step (S04) of performing a control of a first monitor unit, a second monitor unit, and other apparatuses through the control terminal unit based on the control command delivered in the control command delivery step (S03).

That is, the video of the photographed subject is photographed in the video photographing step (S01). In this case, with respect to the photographed video, a video through a separate photographing apparatus may be further photographed together with a video used for the lecture. In this case, the separate photographing apparatus may include an mage sensor for recognition of the gesture.

The video analysis step (S02) may be configured to include a movement recognition step (S02a) of recognizing the movement and a movement command judgment step (S02b) of judging the command of the photographed subject based on the recognized movement.

When more easily described, as illustrated in FIG. 3, the movement is recognized by performing the movement recognition step (S02a) of simplifying and recognizing the gesture in the video into 2D through the processing apparatus unit from video information photographed in the video photographing step (S01). In this case, in the movement recognition step (S02a), the gesture may be recognized by using both the video photographed for the lecture and the video photographed by the separate photographing apparatus.

The movement or gesture recognized through the movement recognition step (S02a) may confirm a command corresponding to the relevant movement by performing a comparison with movement information pre-input through the movement command judgment step (S02b).

Further, as illustrated in FIG. 3, the video analysis step (S02) may be configured to include a voice recognition step (S02c) of recognizing the voice, a voice analysis step (S02d) of analyzing voice contents through a natural language analysis based on the recognized voice contents, and a voice command judgment step (S02e) of judging the command of the photographed subject based on the analyzed contents.

That is, in the video analysis step (S02), the voice may be recognized in sound information included in the video through the voice recognition step (S02c), the contents of the voice may be confirmed from the recognized voice through the voice analysis step (S02d), and a command corresponding to the relevant voice may be confirmed by comparing with the voice command pre-input through the voice command judgment step (S02e) based on the confirmed contents.

In the control command delivery step (S03), the commands confirmed in the movement command judgment step (S02b) and the voice command judgment step (S02e) are delivered to the control terminal unit. In this case, each of the command through the movement judged in the movement command judgment step (S02b) and the command through the voice judged in the voice command judgment step (S02e) is independently delivered to the control terminal unit.

In the control performing step (S04), the commands independently delivered through the control command delivery step (S03) are performed through the control terminal unit to control images displayed I the first monitor unit and the second monitor unit, and other apparatuses.

Through such a step, in the method for controlling the AI studio systems according to the present invention, the photographed subject may simply control the system by the movement or voice, and perform the control so as to prevent a flow of the lecture from being cut, thereby enhancing the satisfaction of the photographed subject.

Moreover, continuous learning is performed based on the deep learning and as a judgment speed for the command and an execution speed of the command are enhanced as the AI studio systems are used, thereby further increasing use convenience.

The spirit of the present invention should not be defined only by the described exemplary embodiments, and it should be appreciated that claims to be described below and all things which are equivalent to the claims or equivalently modified to the claims are included in the scope of the spirit of the present invention.

### EXPLANATION OF REFERENCE NUMERALS AND SYMBOLS

110: Photographing apparatus unit
120: Processing apparatus unit
130: First monitor unit
140: Second monitor unit
150: Control terminal unit
S01: Video photographing step
S02: Video analysis step
S02a: Movement recognition step
S02b: Movement command judgment step
S02c: Voice recognition step
S02d: Voice analysis step
S02e: Voice command judgment step
S03: Control command delivery step
S04: Control performing step

What is claimed is:

1. AI studio systems for online lectures, comprising:
a photographing apparatus unit (110) photographing a photographed subject;
a processing apparatus unit (120) receiving a video and a voice photographed by the photographing apparatus unit (110) and processing the video and voice;
a first monitor unit (130) receiving at least one image of a viewer from the processing apparatus unit (120) and displaying the image so as to be confirmed by the photographed subject;
a second monitor unit (140) receiving a currently output screen from the processing apparatus unit (120) and displaying the screen so as to be confirmed by the photographed subject, and
a control terminal unit (150) controlling the first monitor unit (130) and the second monitor unit (140) based on information of the processing apparatus unit (120).

2. The AI studio systems for online lectures of claim 1, wherein the processing apparatus unit (120) recognizes a movement of the photographed subject in the video photographed by the photographing apparatus unit (110).

3. The AI studio systems for online lectures of claim 2, wherein the processing apparatus unit (120) controls the first monitor unit (130) and the second monitor unit (140) through the control terminal unit (150) according to the recognized movement of the photographed subject.

4. The AI studio systems for online lectures of claim 3, wherein the processing apparatus unit (120) recognizes voice information photographed by the photographing apparatus unit (110).

5. The AI studio systems for online lectures of claim 4, wherein the processing apparatus unit (120) controls the first monitor unit (130) and the second monitor unit (140) through the control terminal unit (150) according to a recognized voice command of the photographed subject.

6. A method for controlling AI studio systems for online lectures, the method comprising:
a video photographing step (S01) of photographing a video including a movement and a voice of a photographed subject;
a video analysis step (S02) of analyzing the movement and the voice of the photographed subject included in the video photographed in the video photographing step (S01);
a control command delivery step (S03) of delivering a control command to a control terminal unit based on information analyzed in the image analyzing step (S02), and
a control performing step (S04) of performing a control of a first monitor unit and a second monitor unit through a control terminal unit based on the control command delivered in the control command delivery step (S03).
